(19) United States
(12) Patent Application Publication
(10) Pub. No.: US 2019/0294373 A1
(43) Pub. Date: Sep. 26, 2019

(54) STORAGE DEVICE MOUNTED ON NETWORK FABRIC AND QUEUE MANAGEMENT METHOD THEREOF

(71) Applicant: SAMSUNG ELECTRONICS CO., LTD., Suwon-si (KR)

(72) Inventors: CHANGDUCK LEE, HWASEONG-SI (KR); KWANGHYUN LA, UIWANG-SI (KR); KYUNGBO YANG, HWASEONG-SI (KR); HWASEOK OH, YONGIN-SI (KR)

(21) Appl. No.: 16/193,907

(22) Filed: Nov. 16, 2018

(30) Foreign Application Priority Data
Mar. 26, 2018 (KR) 10-2018-0034453

(51) Int. Cl. G06F 3/06; H04L 12/947

(52) U.S. Cl. CPC G06F 3/0659; H04L 49/25; G06F 3/0604; G06F 3/0679

(57) ABSTRACT

A queue management method of a storage device which is connected to a network fabric and which includes a plurality of nonvolatile memory devices, includes receiving a write command and write data provided from a host through the network fabric, writing the write command to a command submission queue and writing the write data to a data submission queue, wherein the data submission queue is managed independently of the command submission queue, and executing the write command written to the command submission queue to write the write data written to the data submission queue to a first target device of the plurality of nonvolatile memory devices.

### CROSS-REFERENCE TO RELATED APPLICATIONS

A claim of priority under 35 U.S.C. § 119 is made to Korean Patent Application No. 10-2018-0034453 filed on Mar. 26, 2018, in the Korean Intellectual Property Office, the entirety of which is hereby incorporated by reference.

### BACKGROUND

The present disclosure relates to semiconductor memory devices, and more particularly to storage devices mounted on a network fabric and a queue management method thereof.

Solid state drive (hereinafter referred to as an “SSD”) is an example of a flash memory based mass storage device. The use of SSDs has recently diversified as the demand for mass storage has increased. For example, SSDs may be characterized as subdivided into SSDs implemented for use as servers, SSDs implemented for client use, and SSDs implemented for data centers, among various other implementations. An SSD interface is used to provide the highest speed and reliability suitable for the implementation. For the purpose of satisfying the requirement of high speed and reliability, the non-volatile memory express (NVMe) interface specification which is based on Serial Advanced Technology Attachment (SATA), Serial Attached Small Component Interface (SAS), or Peripheral Component Interconnection Express (PCIe) has been actively developed and applied.

Currently, SSD interfaces that enable ease of expandability in systems such as large-capacity data centers are actively being developed. In particular, an NVMe over fabrics (NVMe-oF) specification is actively being developed as a standard for mounting an SSD on a network fabric such as an Ethernet switch. The NVMe-oF supports an NVMe storage protocol through various storage networking fabrics (e.g., an Ethernet, a Fibre Channel™, and InfiniBand™).

The NVMe storage protocol is also applied to the NVMe SSD. Accordingly, in storage including the NVMe SSD, at least one interface block connected to a network fabric has only the following function: a function of translating a protocol of the network fabric to NVMe-oF protocol or a buffer function. However, in this case, since there is a need to translate a protocol corresponding to a plurality of protocol layers, an increase in latency is inevitable. In addition, in a hardware interface corresponding to each protocol, a structure of a submission queue SQ and a structure of a completion queue CQ have to be consistently maintained. Accordingly, it is difficult to efficiently manage a queue in network storage such as NVMe-oF.

### SUMMARY

Embodiments of the inventive concepts provide a method of simplifying a controller structure of a storage device connected to a network fabric and effectively managing a queue.

Embodiments of the inventive concepts provide a queue management method of a storage device which is connected to a network fabric, the storage device including a plurality of nonvolatile memory devices. The method includes the storage device receiving a write command and write data provided from a host through the network fabric; the storage device writing the write command to a command submission queue and writing the write data to a data submission queue; the storage device managing the data submission queue independently of the command submission queue; and the storage device executing the write command written to the command submission queue to write the write data from the data submission queue to a first target device of the plurality of nonvolatile memory devices.

Embodiments of the inventive concepts further provide a storage device including a plurality of nonvolatile memory devices; and a storage controller configured to provide interfacing between the plurality of nonvolatile memory devices and a network fabric. The storage controller includes a host interface configured to provide the interfacing with the network fabric; a memory configured to implement a queue of a single layer; and a storage manager configured to manage the queue and to control the plurality of nonvolatile memory devices. The storage manager is configured to implement and manage the queue in the memory, for managing a command and data provided from a host. The queue includes a command submission queue configured to hold a write command or a read command provided from the host; a data submission queue configured to hold write data provided together with the write command, wherein the data submission queue is managed independently of the command submission queue; and a completion queue configured to hold read data output from at least one of the plurality of nonvolatile memory devices in response to the read command.

Embodiments of the inventive concepts still further provide a network storage controller which provides interfacing between a plurality of nonvolatile memory devices and a network fabric. The network storage controller includes a host interface configured to provide the interfacing with the network fabric; a flash interface configured to control the plurality of nonvolatile memory devices; a working memory configured to implement a queue for processing a command or data provided from a host; and a processor configured to execute a storage manager. The storage manager is configured to translate a transmission format of a multi-protocol format provided from the host through the network fabric to the command or the data, and the queue corresponds to a single protocol layer and is divided into a command submission queue and a data submission queue.

### BRIEF DESCRIPTION OF THE FIGURES

The above and other objects and features of the inventive concepts will become apparent from the following detailed description taken in view of the accompanying drawings.

FIG. 1 illustrates a block diagram of network storage according to an embodiment of the inventive concepts.

FIG. 2 illustrates a block diagram of an exemplary configuration of a storage controller of FIG. 1.

FIG. 3 illustrates a block diagram of nonvolatile memory devices illustrated in FIG. 1.

FIG. 4 illustrates a diagram of a queue management method according to an embodiment of the inventive concepts.

FIG. 5 illustrates a flowchart of a queue management method according to an embodiment of the inventive concepts.

FIG. 6 illustrates a flowchart of a queue management method according to another embodiment of the inventive concepts.

FIG. 7 illustrates a diagram of a method of performing a read command and a write command having the same ID, described with reference to FIG. 6.

FIG. 8 illustrates a diagram of a structure of a transmission frame processed by a storage controller according to an embodiment of the inventive concepts.

FIG. 9 illustrates a diagram of a feature of a storage controller according to an embodiment of the inventive concepts.

FIG. 10 illustrates a block diagram of a storage device according to another embodiment of the inventive concepts.

FIG. 11 illustrates a block diagram of a network storage system according to an embodiment of the inventive concepts.

### DETAILED DESCRIPTION

As is traditional in the field of the inventive concepts, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the inventive concepts. Likewise, the blocks of the embodiments may be physically combined into more complex blocks without departing from the scope of the inventive concepts.

Below, a solid state drive (SSD) using a flash memory device will be used as an example of a storage device for describing the features and functions of the inventive concepts. However, one skilled in the art may easily understand other merits and performance of the inventive concepts depending on the contents disclosed here. The inventive concept may be implemented or applied through other embodiments. In addition, the detailed description may be changed or modified according to applications without departing from the scope and spirit, and any other purposes of the inventive concepts.

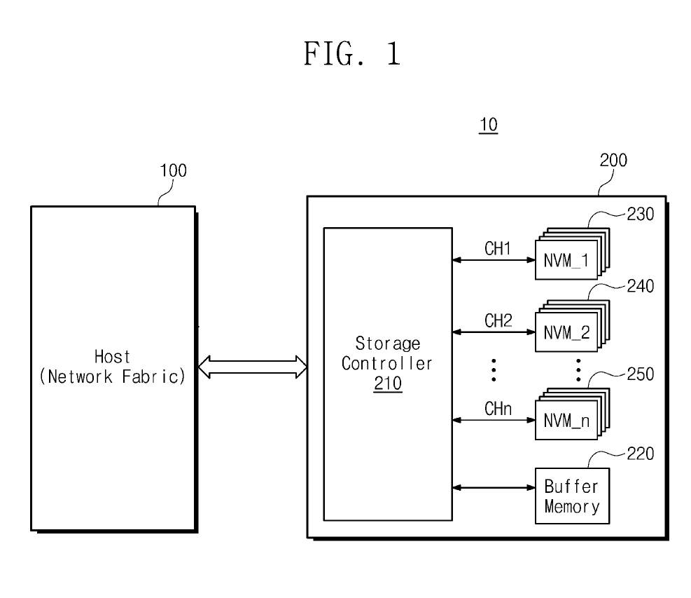

FIG. 1 illustrates a block diagram of network storage 10 according to an embodiment of the inventive concepts. Referring to FIG. 1, network storage 10 includes a host 100 and a storage device 200. The host 100 transmits a command and data of (i.e., using) an Ethernet protocol to the storage device 200. The storage device 200 may receive the transmission and translate the Ethernet protocol format of the transmission to a command and data to be directly transmitted to a flash memory without intermediate translation. This will be subsequently described in more detail.

The host 100 may write data to the storage device 200 or may read data stored in the storage device 200. That is, the host 100 may be a network fabric or a switch using the Ethernet protocol, or a server which is connected to the network fabric and controls the storage device 200. When transmitting a command and data to the storage device 200, the host 100 may transmit the command and the data in compliance with the Ethernet protocol including an NVMe over fabrics (NVMe-oF) storage protocol (which may hereinafter be referred to as an NVMe-oF protocol). Also, when receiving a response or data from the storage device 200, the host 100 may receive the response or the data in compliance with the Ethernet protocol.

In response to a command CMD or data from the host 100, the storage device 200 may access nonvolatile memory devices 230, 240, and 250 or may perform various requested operations. The storage device 200 may directly translate a command or a data format from the host 100 to a command or a data format for controlling the nonvolatile memory devices 230, 240, and 250. For the purpose of performing the translation and other functions, the storage device 200 includes a storage controller 210. In the storage controller 210, transmission formats for supporting an Ethernet protocol, an NVMe-oF protocol, and an NVMe protocol may be processed at a single layer. The storage controller 210 may be implemented with a single chip. To this end, the storage device 200 includes the storage controller 210, a buffer memory 220, and the plurality of nonvolatile memory devices 230, 240, and 250 connected to the storage controller 210 via memory channels CH1, CH2, . . . CHn.

The storage controller 210 provides interfacing between the host 100 and the storage device 200. The storage controller 210 may directly translate a command or a data format of an Ethernet protocol format (e.g., a packet) provided from the host 100 to a command or a data format to be applied to the nonvolatile memory devices 230, 240, and 250. In the storage controller 210, transmission formats for supporting an Ethernet protocol, an NVMe-oF protocol, and an NVMe protocol may be processed at a single layer. A detailed operation of the storage controller 210 will be described later.

According to the above description, the storage device 200 of the inventive concepts includes the storage controller 210 which may directly translate a network protocol to a command or data format of the nonvolatile memory device. Accordingly, a command and data transmitted from the network fabric may be loaded/stored to the nonvolatile memory devices 230, 240, and 250 after being processed through a command path and a data path, which are separate from each other. In this case, successive access commands targeted for a nonvolatile memory device of the same ID may be concurrently processed.

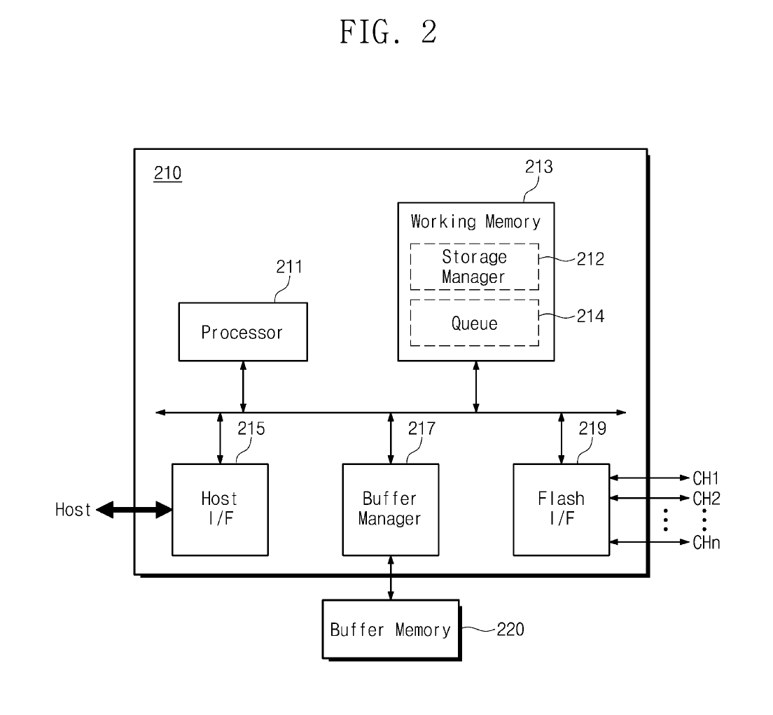

FIG. 2 illustrates a block diagram of an exemplary configuration of a storage controller of FIG. 1. Referring to FIG. 2, the storage controller 210 of the inventive concepts includes a processor 211, a working memory 213, a host interface (IF) 215, a buffer manager 217, and a flash interface (IF) 219 interconnected by a bus.

The processor 211 provides a variety of control information needed to perform a read/write operation on the nonvolatile memory devices 230, 240, and 250 (see FIG. 1), to registers of the host interface 215 and the flash interface 219. The processor 211 may operate based on firmware or an operating system OS provided for various control operations of the storage controller 210. For example, the processor 211 may execute a flash translation layer (FTL) for garbage collection, address mapping, and wear leveling from among various control operations for managing the nonvolatile memory devices 230, 240, and 250. In particular, the processor 211 may call and execute a storage manager 212 loaded in the working memory 213. As the storage manager 212 is executed, the processor 211 may process transmission formats for supporting an Ethernet protocol, an NVMe-oF protocol, and an NVMe protocol with respect to a command or data provided from the host 100 (or the network fabric), at a single layer. In addition, the processor 211 may load/store a command and data transmitted from the network fabric to the nonvolatile memory devices 230, 240, and 250 after being processed through a command path and a data path, which are separate from each other.

The working memory 213 may be used as an operation memory, a cache memory, or a buffer memory. The working memory 213 may store codes or commands which the processor 211 executes. The working memory 213 may store data processed by the processor 211. In an embodiment, the working memory 213 may be implemented with a static random access memory (SRAM). In particular, the storage manager 212 may be loaded to the working memory 213. When executed by the processor 211, the storage manager 212 may process conversion of a transmission format of a command or data provided from the host 100 at a single layer. In addition, the storage manager 212 may process a command or data transmitted from the network fabric in a state where a command path and a data path are separate. In addition, the flash translation layer FTL or various memory management modules may be stored in the working memory 213. Also, a queue 214 in which a command submission queue CMD SQ and a data submission queue DATA SQ are separately (i.e., independently) managed may be implemented on the working memory 213. In embodiments of the inventive concepts, the storage manager 212 may control the working memory 213 to implement or be configured to include a queue of a single layer (e.g., queue 214) and to manage the queue, for managing a command CMD and data provided from the host 100 (FIG. 1).

The storage manager 212 may collect and adjust overall information about the nonvolatile memory devices 230, 240, and 250. For example, the storage manager 212 may maintain and update status or mapping information of data stored in the nonvolatile memory devices 230, 240, and 250. Accordingly, even though an access request is made from the network fabric, the storage manager 212 may provide data requested at high speed to the network fabric or may write write-requested data. In addition, since the storage manager 212 has the authority to manage a mapping table for managing an address of data, the storage manager 212 may perform data migration between the nonvolatile memory devices 230, 240, and 250 or correction of mapping information if necessary.

The host interface 215 may communicate with the host 100 which is connected to an Ethernet-based switch such as a network fabric. For example, the host interface 215 provides interfacing between the storage device 200 and a high-speed Ethernet system such as a Fibre Channel™ or InfiniBand™. The host interface 215 may include at least one Ethernet port for connection with the network fabric.

The buffer manager 217 may control read and write operations of the buffer memory 220 (refer to FIG. 1). For example, the buffer manager 217 temporarily stores write data or read data in the buffer memory 220. The buffer manager 217 may classify and manage a memory area of the buffer memory 220 in units of streams under control of the processor 211.

The flash interface 219 may exchange data with the nonvolatile memory devices 230, 240, and 250. The flash interface 219 may write data transmitted from the buffer memory 220 to the nonvolatile memory devices 230, 240, and 250 through respective memory channels CH1 to CHn. Read data provided from the nonvolatile memory devices 230, 240, and 250 through the memory channels CH1 to CHn may be collected by the flash interface 219. Afterwards, the collected data may be stored in the buffer memory 220.

The storage controller 210 of the above-described structure may translate a network protocol of communication with the host 100 through the Ethernet port directly to a command or data of a flash memory level. Accordingly, a command or data provided through the network fabric may not experience a plurality of sequential translation processes, which are performed through, for example, an Ethernet network interface card (NIC), a TCP/IP offload engine, and a PCIe switch. According to the above-described feature, a command or data transmitted from the host 100 may be loaded/stored to the nonvolatile memory devices 230, 240, and 250 after being processed through a command path and a data path, which are separate from each other. In this case, sequential access commands targeted for a nonvolatile memory device of the same ID may be concurrently processed.

In particular, the storage controller 210 may be implemented with a single chip. As the storage controller 210 is implemented with a single chip, the storage device 200 of the inventive concepts may be lightweight, thin, and small-sized. Accordingly, the storage device 200 of the inventive concept may provide low latency, economic feasibility, and high expandability on the network fabric.

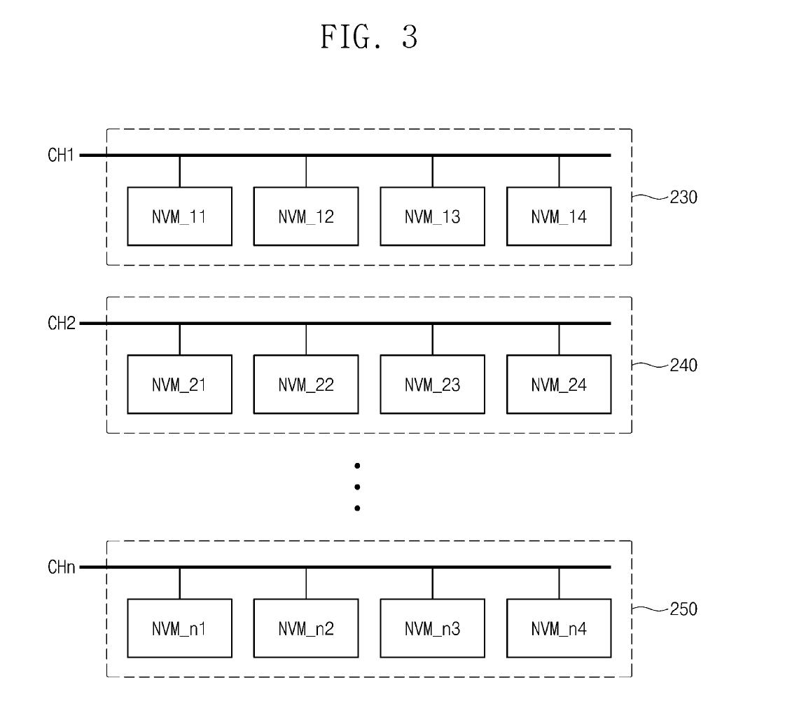

FIG. 3 illustrates a block diagram of nonvolatile memory devices illustrated in FIG. 1. Referring to FIG. 3, the nonvolatile memory devices 230, 240, and 250 may be directly connected to the storage controller 210 and may exchange data with the storage controller 210.

In an embodiment, the nonvolatile memory devices 230, 240, and 250 may be divided in units of channels. For example, one channel may be a data path between the storage controller 210 and nonvolatile memory devices sharing the same data line DQ. That is, nonvolatile memory devices NVM_11, NVM_12, NVM_13, and NVM_14 connected to the first channel CH1 may share the same data line. Nonvolatile memory devices NVM_21, NVM_22, NVM_23, and NVM_24 connected to the second channel CH2 may share the same data line. Nonvolatile memory devices NVM_n1, NVM_n2, NVM_n3, and NVM_n4 connected to the n-th channel CHn may share the same data line.

However, the manner in which the nonvolatile memory devices 230, 240, and 250 and the flash interface 219 are connected is not limited to the above-described channel sharing way. For example, nonvolatile memory devices may be connected to the flash interface 219 in a cascade manner by using a flash switch which allows direct expansion and connection of flash memory devices.

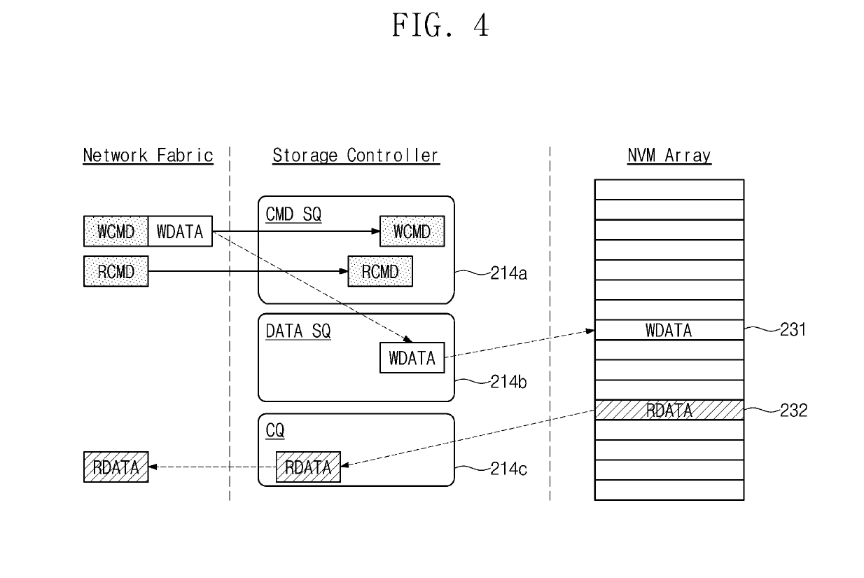

FIG. 4 illustrates a diagram of a queue management method according to an embodiment of the inventive concepts. Referring to FIG. 4, the storage controller 210 of the inventive concepts may manage a command and data by using a submission queue SQ and a completion queue CQ. In particular, the submission queue SQ of the inventive concept may be divided into a command submission queue CMD SQ 214a (which may hereinafter be referred to as command submission queue 214a) and a data submission queue DATA SQ 214b (which may hereinafter be referred to as data submission queue 214b). Accordingly, the storage controller 210 may process commands continuously (e.g., successively) provided through the network fabric without delay. The division of the submission queue SQ may be possible depending on step reduction of a translation operation performed in the storage controller 210.

Write command WCMD and write data may be transmitted from the network fabric to the storage controller 210. In addition, it is assumed that read command RCMD is transmitted For example, in an embodiment the read command RCMD may be transmitted after the write command WCMD is transmitted, so that the storage controller 210 of the storage device 200 may receive the read command RCMD following the write command WCMD. The storage controller 210 may skip a translation process of an Ethernet protocol, an NVMe-oF protocol, and a PCIe protocol and may directly translate a command and data corresponding to a payload of a transmission frame to a command and data which may be recognized by the nonvolatile memory device 230.

Next, the storage controller 210 separates the translated write command WCMD and the translated write data WDATA. The storage controller 210 writes and manages the separated write command WCMD to the command submission queue 214a. The storage controller 210 writes and manages the separated write data WDATA to a data submission queue 214b. In addition, the read command RCMD input together with the write data WDATA may be written to the command submission queue 214a. The command submission queue 214a may store or hold write commands WCMD and read commands RCMD transmitted from the network fabric (i.e., host 100 in FIG. 1). The data submission queue 214b may store or hold write data WDATA transmitted from the network fabric (i.e., host 100).

As the write command WCMD written to the command submission queue 214a is executed, the write data WDATA written to the data submission queue 214b may be programmed to the nonvolatile memory device 230 selected by the storage controller 210. That is, the write data WDATA write-requested by the write command WCMD may be written to a first target device 231 of the nonvolatile memory device 230 (i.e., NVM array in FIG. 4) through the data submission queue 214b.

At the same time, as the read command RCMD written to the command submission queue 214a is executed, the storage manager 212 may control the flash interface 219 such that read data RDATA are read from a second target device 232 requested for access. In this case, the flash interface 219 may control the second target device 232 such that the read data RDATA stored therein are output to the storage controller 210. The read data RDATA output from the second target device 232 are written to a completion queue (CQ) 214c (which may hereinafter be referred to as completion queue 214c). The completion queue 214b may store or hold read data RDATA output from the second target device 232. Afterwards, the read data RDATA stored in the completion queue 214c may be translated to a transmission frame of the same multi-protocol as the read command RCMD, and the transmission frame may be transmitted to the host 100.

Here, a description is given as the command submission queue 214a, the data submission queue 214b, and the completion queue 214c are implemented in a specific area of the working memory 213 of FIG. 2. However, it may be well understood that the command submission queue 214a, the data submission queue 214b, and the completion queue 214c may be implemented in the buffer memory 220 or on various memories, if necessary.

According to the above description, a submission queue SQ of the storage controller 210 of the inventive concepts may be divided into the command submission queue CMD SQ 214a in which a command entry is written, and the data submission queue DATA SQ 214b in which data are written, and a command and data may be independently managed through the command submission queue CMD SQ and the data submission queue DATA SQ upon writing data to the nonvolatile memory devices 230, 240, and 250. The storage controller 210 of the storage device 200 may manage the data submission queue DATA SQ independently of the command submission queue CMD SQ. Accordingly, even though a write operation and a read operation are concurrently requested from a target device having the same ID, a write command and a read command may be continuously fetched from the command submission queue 214a for execution. As a result, a write command and a read command which are continuous (i.e., successive) are quickly processed without a delay.

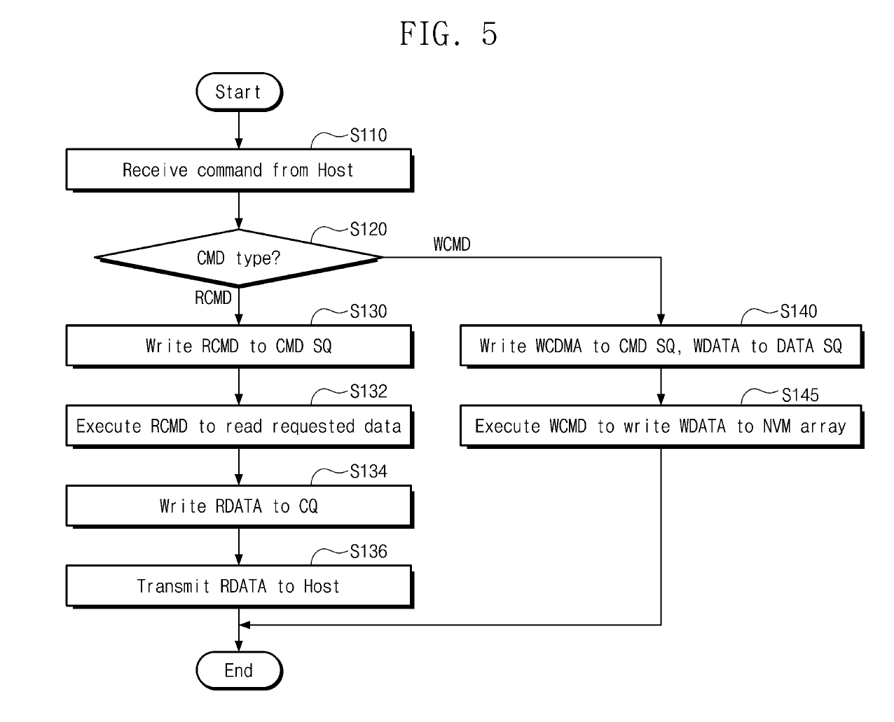

FIG. 5 illustrates a flowchart of a queue management method according to an embodiment of the inventive concepts. Referring to FIG. 5, when receiving a read command or a write command from the host 100, the storage device 200 may separately manage a command entry and a data entry. In the management method as described hereinafter with respect to FIG. 5, the processor 211 as shown in FIG. 2 provides various control of the circuits in the storage controller 210 to perform the operations, and may call and execute the storage manager 212.

In operation S110, the storage device 200 receives a command from the host 100. A command received from the host 100 through a network fabric includes protocol fields corresponding to a multi-protocol. A field associated with an Ethernet protocol among the multiple protocol fields may be processed through a translation operation for the purpose of receiving or transmitting data. However, in practice, fields corresponding to NVMe-oF and PCIe protocols not included as hardware in the storage controller 210 may be removed without a separate translation process. In this case, only a command or data field may remain. For example, the received command from the host 100 may be a read command RCMD, or the received command from the host may be a write command WCMD including write data WDATA.

In operation S120, the storage controller 210 detects a command type. The storage controller 210 manages processing of accompanying data in a different manner depending on the command type. That is, when the detected command type corresponds to a read command RCMD, the procedure proceeds to operation S130. In contrast, when the detected command type corresponds to a write command WCMD, the procedure proceeds to operation S140.

In operation S130, the storage controller 210 writes a read command RCMD entry to the command submission queue CMD SQ 214a (FIG. 4).

In operation S132, the storage controller 210 executes the read command with reference to the command entry written to the command submission queue CMD SQ 214a. For example, the storage controller 210 may access the second target device 232 (FIG. 4) with reference to an address included in the read command Next, the storage controller 210 may be provided with requested read data RDATA from the second target device 232.

In operation S134, the storage controller 210 writes the read data RDATA output from the second target device 232 to the completion queue CQ 214c.

In operation S136, the storage controller 210 transmits the read data RDATA written to the completion queue CQ 214c to the host 100 through a network fabric. In this case, the storage controller 210 forms a transmission frame by adding the previously removed protocol fields and the Ethernet protocol field to the read data. Afterwards, the storage controller 210 transmits the transmission frame thus completed to the host 100 through the network fabric.

In operation S140, the storage controller 210 separates the write command WCMD and the write data WDATA. The storage controller 210 writes the separated write command WCMD to the command submission queue CMD SQ 214a. The storage controller 210 writes the separated write data WDATA to the data submission queue DATA SQ 214b.

In operation S145, the storage controller 210 executes the write command WCMD written to the command submission queue CMD SQ 214a. As the write command WCMD is executed, the write data WDATA written to the data submission queue DATA SQ 214b is programmed to the nonvolatile memory device 230 selected by the storage controller 210. For example, the write data WDATA write-requested by the write command WCMD may be written to the first target device 231 of the nonvolatile memory device 230 through the data submission queue DATA SQ 214b.

The queue management method of the inventive concepts is briefly described above. With regard to the submission queue SQ, the storage controller 210 of the inventive concepts may separately manage the command submission queue CMD SQ 214a for writing a command entry and the data submission queue DATA SQ 214b for writing write data. A read command and a write command which are continuous as continuous commands are sequentially supplied to the command submission queue CMD SQ 214a and may be executed without latency.

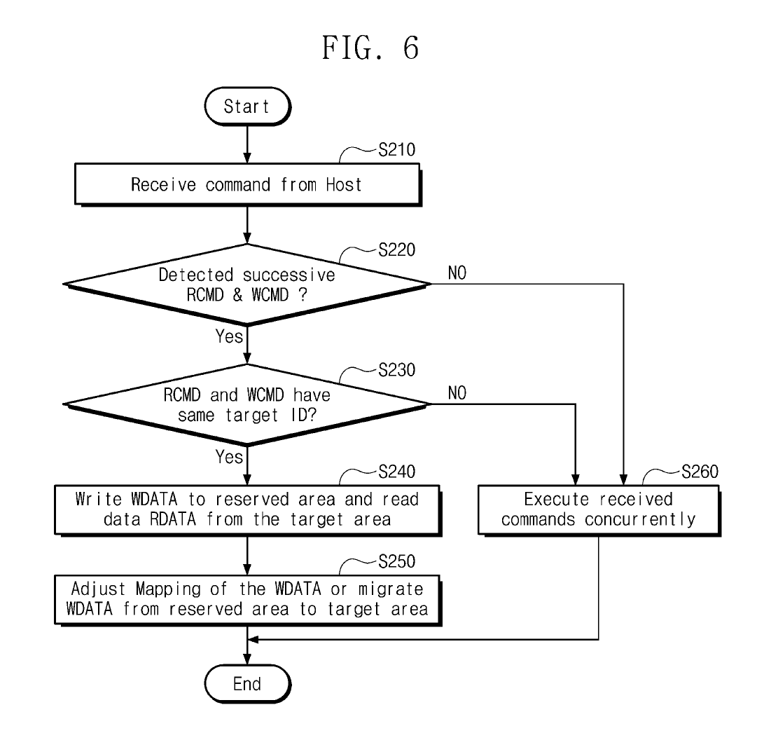

FIG. 6 illustrates a flowchart of a queue management method according to another embodiment of the inventive concept. Referring to FIG. 6, even though the storage device 200 continuously receives a read command and a write command targeted to a nonvolatile memory device of the same ID, the storage device 200 may process the read command the write command without latency. In the management method as described hereinafter with respect to FIG. 6, the processor 211 as shown in FIG. 2 provides various control of the circuits in the storage controller 210 to perform the operations, and may call and execute the storage manager 212.

In operation S210, the storage controller 210 receives a command from the host 100. A command and data may be extracted by removing multiple protocol fields of a command received from the host 100 through the network fabric.

In operation S220, the storage controller 210 detects whether the read command RCMD and the write command WCMD successively input to the command submission queue CMD SQ 214a exist. The existence of successively input commands may be determined by detecting command entries successively input to the command submission queue CMD SQ 214a. When successive read and write commands RCMD and WCMD are detected (Yes in S220), the procedure proceeds to operation S230. In contrast, when successive read and write commands RCMD and WCMD are not detected (No in S220), the procedure proceeds to operation S260.

In operation S230, the storage controller 210 detects whether the successive read and write commands RCMD and WCMD have the same ID, or in other words are directed to the same target device to be accessed. That is, the storage controller 210 detects whether the successive read and write commands RCMD and WCMD are associated with the same target device to be accessed. When the successive read and write commands RCMD and WCMD have the same target device value, or in other words are directed to the same target device, (Yes in S230), the procedure proceeds to operation S240. When the successive read and write commands RCMD and WCMD have different target device values, or in other words are directed to different target devices, (No in S230), the procedure proceeds to operation S260.

In operation S240, the storage controller 210 writes the write data WDATA to a reserved area for the purpose of executing the write command WCMD. In this case, the storage controller 210 keeps and manages address mapping information of the reserved area. As the read command RCMD is executed, the read data RDATA are read out from the target device. As such, the storage controller 210 executes the successive read and write commands RCMD and WCMD without latency. That is, the storage controller 210 of the storage device 200 may receive a write command WCMD and a read command RCMD following the write command WCMD, and may execute the successive write and read commands WCMD and RCMD without latency using the reserved area.

In operation S250, the storage controller 210 may program (or migrate) the write data WDATA written in the reserved area to the target device. The programming of the write data WDATA to the target device may be performed by using a background operation. Alternatively, the storage controller 210 may correct (or adjust) address mapping information of the write data WDATA in the reserved area such that an address of the reserved area is viewed or recognized as an address of the target device.

In operation S260, the storage controller 210 respectively executes the commands written to the command submission queue CMD SQ 214a. In the case where the read commands RCMD are successively provided or in the case where the write commands WCMD are successively provided, the commands may be concurrently executed in the case where the commands do not have the same ID.

According to the method of accessing a nonvolatile memory device of the inventive concepts, even though read and write commands have the same ID, a read operation and a write operation may be concurrently performed by using separate submission queues. The reason is that the storage controller 210 of the inventive concepts may freely adjust and manage mapping of an address provided from the network fabric and an address of the nonvolatile memory devices 230, 240, and 250.

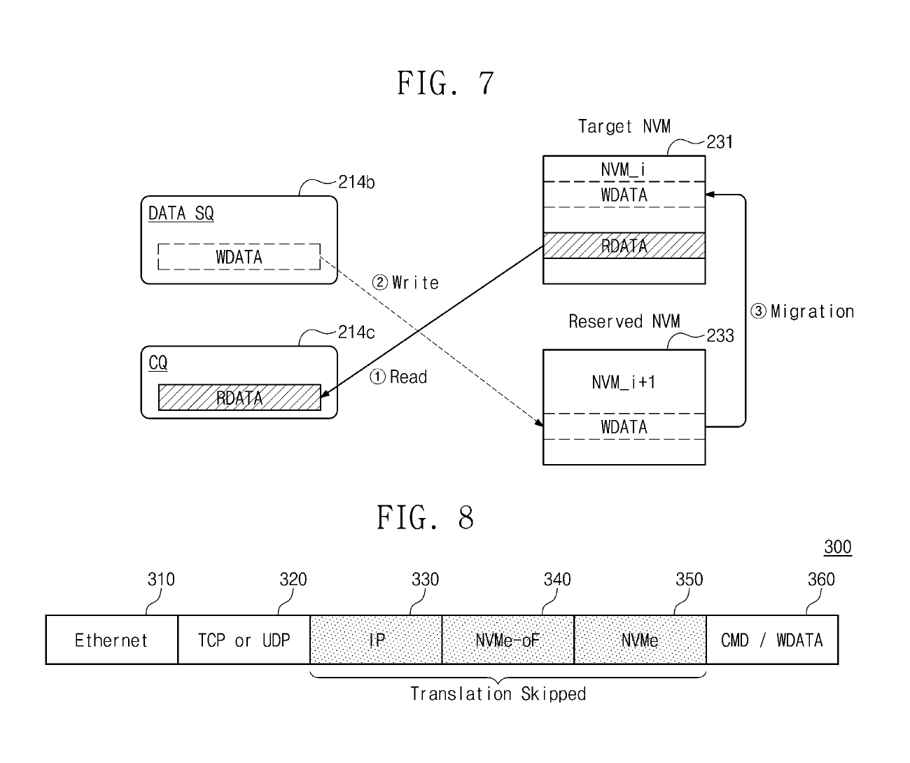

FIG. 7 illustrates a diagram of a method of performing a read command and a write command having the same ID, described with reference to FIG. 6. Referring to FIG. 7, even though the write command WCMD and the read command RCMD have the same ID, the storage controller 210 may concurrently process the write command WCMD and the read command RCMD by using a reserved nonvolatile memory device 233 from among the nonvolatile memory devices connected to the storage controller 210. In this embodiment, it is assumed that the same ID of the read command and the write command is for example the first target device 231 described with respect to FIG. 4.

First, the storage controller 210 executes the read command RCMD and reads the read data RDATA from the target device 231. The read data RDATA thus read are written to the completion queue 214c. This procedure is marked by “\textcircled{1}”. Also, the storage controller 210 executes the write command WCMD and writes the write data WDATA to the reserved device 233. This data flow is marked by “\textcircled{2}”. Here, it may be well understood that a read operation (\textcircled{1}) for the target device 231 and a write operation (\textcircled{2}) for the reserved device 233 are concurrently performed.

When the read operation for the target device 231 and the write operation for the reserved device 233 are completed, the storage controller 210 may allow the write data WDATA stored in the reserved device 233 to migrate to the target device 231. The migration of the write data WDATA is marked by “\textcircled{3}”. The migration of the write data WDATA from the reserved device 233 to the target device 231 may be performed at a time when command entries of the command submission queue 214a are empty.

According to the above description, the storage device 200 of the inventive concepts may process the write command WCMD and the read command RCMD having the same ID without delay. Here, features of the inventive concepts are described by using the migration of the write data WDATA, but the inventive concepts however are not limited thereto. It should be well understood that the same effect as the migration of data may be obtained through adjustment of various mapping without the migration of the write data WDATA.

FIG. 8 illustrates a diagram of a structure of a transmission frame processed by a storage controller according to embodiments of the inventive concepts. Referring to FIG. 8, a frame (or a packet) provided from the host 100 (or the network fabric) may include a header or fields corresponding to multiple protocols.

A transmission frame transmitted from the host 100 to the storage device 200 of the inventive concepts may include an Ethernet field 310, a TCP or UDP field 320, an Internet protocol (IP) field 330, an NVMe-oF field 340, an NVMe field 350, and a command/data field 360. The storage device 200 of the inventive concepts, which supports multiple protocols, may directly translate an Ethernet protocol to an interface format of a nonvolatile memory device without using a submission queue SQ and/or a completion queue CQ at translation steps of respective additional protocols.

For example, a transmission frame corresponding to a multi-protocol may be transmitted from the host 100 to the storage device 200 according to the inventive concepts. The storage controller 210 of the inventive concepts receives a transmission frame or packet by using the Ethernet field 310 and the TCP or UDP field 320. The Ethernet field 310 basically defines a media access control (MAC) address and an Ethernet kind. The TCP or UDP field 320 may include a destination port number of the transmission frame. The storage controller 210 may recognize an Ethernet type or a location of a transmit or receive port on a network by using the Ethernet field 310 or the TCP or UDP field 320.

In contrast, the storage device 200 may not perform separate protocol translation on the IP field 330, the NVMe-oF field 340, and the NVMe field 350 provided for NVMe-oF storage. Values of the fields 330, 340, and 350 may be provided to recognize a transmission frame with regard to multiple protocols. The storage device 200 of the inventive concepts may not have a network interface card, or a hardware interface for processing an NVMe protocol. That is, since data received at an Ethernet layer are directly transmitted to a flash interface, there is no need to have queues respectively corresponding to multiple protocols.

The storage controller 210 of the inventive concepts may restore the command/data field 360 without protocol translation associated with the IP field 330, the NVMe-oF field 340, and the NVMe field 350. The storage controller 210 may thus translate the protocol format of the transmission frame once and then perform interfacing with the nonvolatile memory devices 230, 240 and 250. The skipping of the protocol translation operation associated with the IP field 330, the NVMe-oF field 340, and the NVMe field 350 may be possible by function of the storage manager 212 (refer to FIG. 2).

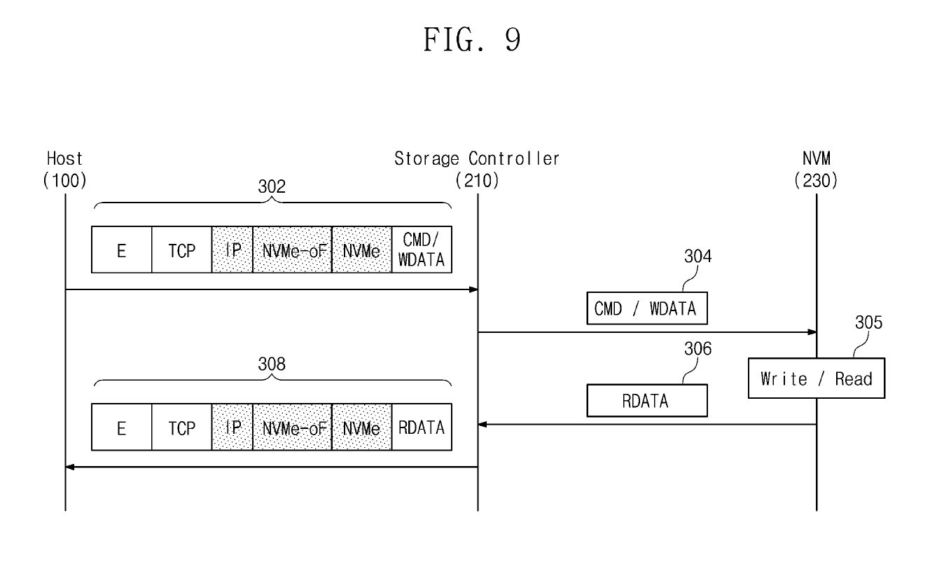

FIG. 9 illustrates a diagram of a feature of a storage controller according to embodiments of the inventive concepts. Referring to FIG. 9, the storage controller 210 may only extract a command or data from a transmission format transmitted from the host 100 and may directly control the nonvolatile memory device 230. The storage controller 210 of the inventive concepts is not limited to operating based on sequential translation of protocols. Accordingly, management of queues which may typically be configured and perform at respective protocol layers may, in embodiments of the inventive concepts, be configured and perform at a single layer. For example, in embodiments of the inventive concepts, a queue may be managed to be configured and perform at, or to be responsive to or correspond to, a single protocol layer, or in other words at a single layer. In addition, since the queues are managed to be configured and perform at or responsive to a single protocol layer (i.e., a single layer), the separation of a command submission queue and a data submission queue is possible. In such a case, a queue in embodiments of the inventive concepts may be characterized as a queue of a single layer.

In detail, for the purpose of accessing the nonvolatile memory device 230 through a network fabric, the host 100 may transmit a command or data having a field (or a header) corresponding to a plurality of protocol layers to the storage controller 210. Here, it is assumed that a plurality of protocols include, for example, an Ethernet protocol, an NVMe-oF protocol, and an NVMe protocol. According to this assumption, a transmission frame 302 transmitted from the host 100 to the storage controller 210 may include an Ethernet field “E”, a TCP field TCP, an IP field IP, an NVMe-oF field NVMe-oF, an NVMe field NVMe, and a command/data field CMD/WDATA.

The storage controller 210 may access the nonvolatile memory device 230 by using only the command/data field CMD/WDATA, without translation for the IP field IP, the NVMe-oF field NVMe-oF, and the NVMe field NVMe. The storage controller 210 may generate, maintain, and update overall mapping information about an address of the nonvolatile memory device 230 and an address on an Ethernet provided from the host 100.

By using the command/data field CMD/WDATA, the flash interface 219 (refer to FIG. 2) may transmit a write command to the nonvolatile memory device 230 and may program the write data WDATA. This procedure is illustrated by write/read 305.

In the case where a command transmitted to the nonvolatile memory device 230 is a read command, the nonvolatile memory device 230 may output requested read data (RDATA) 306 to the storage controller 210. In this case, the storage controller 210 writes the read data 306 to the completion queue CQ. Afterwards, the read data RDATA written to the completion queue CQ may be translated to a transmission frame 308 of a network, and the transmission frame 308 may be transmitted to the host 100.

An interfacing operation in which a plurality of protocol translation operations are skipped in the storage device 200 of the inventive concepts is described above. The storage device 200 of the inventive concepts may skip the plurality of protocol translation operations, thus minimizing latency.

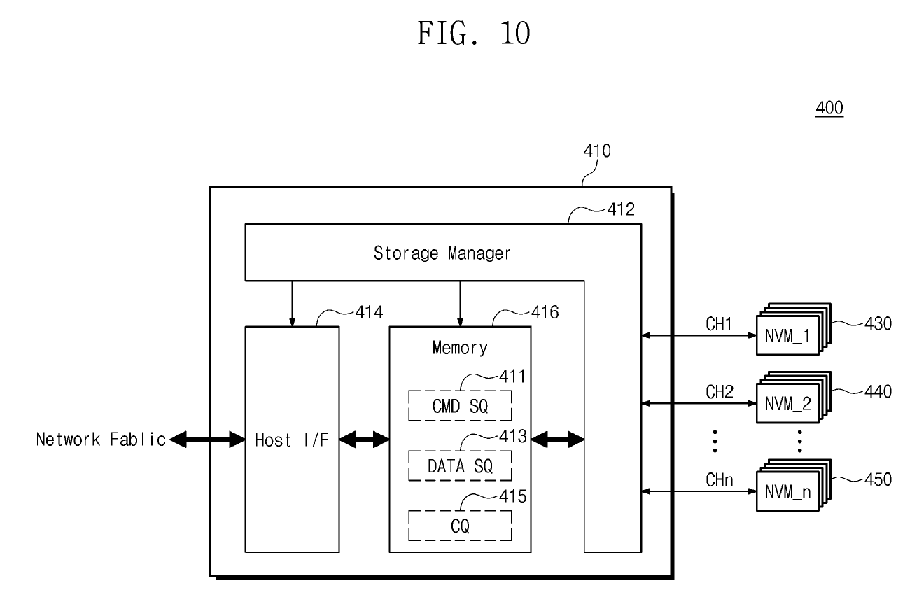

FIG. 10 illustrates a block diagram of a storage device according to another embodiment of the inventive concepts. Referring to FIG. 10, a storage device 400 includes a storage controller 410 and a plurality of nonvolatile memory devices 430, 440, and 450 connected via memory channels CH1, CH2, . . . CHn.

In response to a command CMD or data provided through a network fabric, the storage device 400 may access nonvolatile memory devices 430, 440, and 450 or may perform various requested operations. The storage device 400 may directly translate a command or a data format provided through the network fabric to a command or a data format for controlling the nonvolatile memory devices 430, 440, and 450. For the purpose of performing the translation among other functions, the storage device 400 includes the storage controller 410. In the storage controller 410, transmission formats for supporting an Ethernet protocol, an NVMe-oF protocol, and an NVMe protocol may be processed at a single layer. The storage controller 410 may be implemented with a single chip.

The storage controller 410 provides interfacing between the network fabric and the storage device 400. The storage controller 410 may directly translate a command or a data format of the Ethernet protocol provided from the network fabric to a command or a data format to be applied to the nonvolatile memory devices 430, 440, and 450. In the storage controller 410, transmission formats for supporting an Ethernet protocol, an NVMe-oF protocol, and an NVMe protocol may be processed at a single layer.

The storage controller 410 includes a storage manager 412, a host interface (IF) 414, and a memory 416 for composing a queue. A configuration of the host interface 414 may be substantially the same as the configuration of the host interface 215 of FIG. 2. That is, the host interface 414 may communicate with the network fabric. For example, the host interface 414 provides interfacing between the storage device 400 and a high-speed Ethernet system such as a Fibre Channel™ or InfiniBand™. The host interface 414 may include at least one Ethernet port for connection with the network fabric.

The memory 416 is provided to include a command submission queue (SQ) 411, a data submission queue (SQ) 413, and a completion queue (CQ) 415. That is, as the command submission queue 411 and the data submission queue 413 are separately managed, efficient management is possible.

The storage manager 412 may manage the host interface 414, the memory 416, and the nonvolatile memory devices 430, 440, and 450. The storage manager 412 may process multiple transmission formats for supporting an Ethernet protocol, an NVMe-oF protocol, and an NVMe protocol at a single layer with respect to a command or data provided from the network fabric. In addition, the storage manager 412 may load/store a command and data transmitted from the network fabric to the nonvolatile memory devices 430, 440, and 450 after being processed through a command path and a data path, which are separate from each other.

In addition, the storage manager 412 may include a flash translation layer (FTL) for garbage collection, address mapping, wear leveling, or the like, for managing the nonvolatile memory devices 430, 440, and 450. In particular, the storage manager 412 may collect and adjust overall information about the nonvolatile memory devices 430, 440, and 450. That is, the storage manager 412 may maintain and update status or mapping information of data stored in the nonvolatile memory devices 430, 440, and 450. Accordingly, even though an access request is made from the network fabric, the storage manager 212 may provide data requested at high speed to the network fabric or may write write-requested data. In addition, since the storage manager 412 has the authority to manage a mapping table, the storage manager 412 may perform data migration between the nonvolatile memory devices 430, 440, and 450 or correction of mapping information if necessary.

The storage controller 410 of the above-described structure may be connected to an Ethernet port and may directly translate a network protocol to a command or data of a flash memory level. Accordingly, with regard to a command or data provided from the network fabric, a plurality of sequential translation processes, which are sequentially performed through, for example, an Ethernet network interface card (NIC), a TCP/IP offload engine, and a PCIe switch, may be skipped. According to the above-described feature, a command or data transmitted from the network fabric may be loaded/stored to the nonvolatile memory devices 430, 440, and 450 after being processed through a command path and a data path, which are separate from each other. In this case, sequential access commands targeted for a nonvolatile memory device of the same ID may be concurrently processed.

In particular, the storage controller 410 may be implemented as a single chip. As the storage controller 410 is implemented with a single chip, the storage device 400 of the inventive concepts may be lightweight, thin, and small-sized.

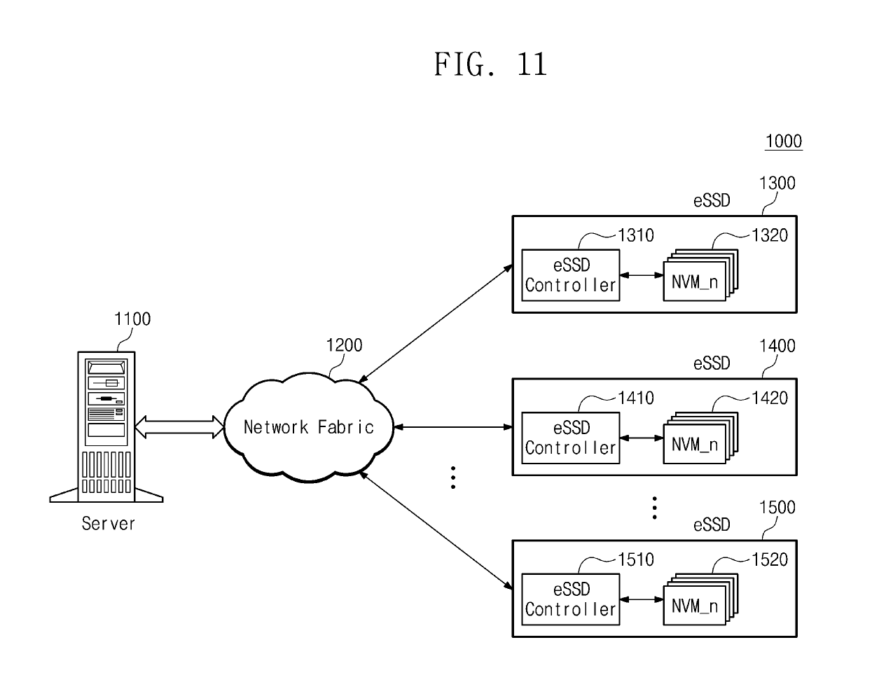

FIG. 11 illustrates a block diagram of a network storage system according to an embodiment of the inventive concepts. Referring to FIG. 11, a network storage system 1000 of the inventive concepts includes a server 1100, a network fabric 1200, and a plurality of Ethernet SSDs 1300, 1400, and 1500.

The server 1100 is connected with the plurality of Ethernet SSDs 1300, 1400, and 1500 through the network fabric 1200. The server 1100 may transmit a command and data to the plurality of Ethernet SSDs 1300, 1400, and 1500 by using an Ethernet protocol. The server 1100 may receive data of the Ethernet protocol provided from at least one of the plurality of Ethernet SSDs 1300, 1400, and 1500. The network fabric 1200 may be a network switch or a PCIe switch.

Each of the plurality of Ethernet SSDs 1300, 1400, and 1500 may be implemented with a storage device of FIG. 1 or 10. That is, Ethernet SSD controllers 1310, 1410, and 1510 included in the plurality of Ethernet SSDs 1300, 1400, and 1500 may control nonvolatile memory devices 1320, 1420, and 1520 by using a queue of a single layer. The queue of the single layer is composed of a command submission queue CMD SQ, a data submission queue DATA SQ, and a completion queue CQ, which are separated from each other.

According to embodiments of the inventive concepts, there is provided a storage controller which may efficiently process a protocol of a command/data provided from a network fabric. In addition, there is provided a queue management method which may concurrently process concurrently or continuously input commands by using a simplified submission queue SQ and a simplified completion queue CQ. The structure makes it possible to markedly reduce latency which occurs in a storage device mounted on a network fabric.

While the inventive concepts have been described with reference to exemplary embodiments thereof, it will be apparent to those of ordinary skill in the art that various changes and modifications may be made thereto without departing from the spirit and scope of the inventive concepts as set forth in the following claims.

What is claimed is:

1. A queue management method of a storage device which is connected to a network fabric, the storage device including a plurality of nonvolatile memory devices, the method comprising:
the storage device receiving a write command and write data provided from a host through the network fabric;
the storage device writing the write command to a command submission queue and writing the write data to a data submission queue;
the storage device managing the data submission queue independently of the command submission queue; and
the storage device executing the write command written to the command submission queue to write the write data from the data submission queue to a first target device of the plurality of nonvolatile memory devices.

2. The method of claim 1, further comprising:
the storage device receiving a read command following the write command; and
the storage device writing the read command to the command submission queue.

3. The method of claim 2, further comprising the storage device accessing a second target device of the plurality of nonvolatile memory devices and reading read data from the second target device in response to the read command.

4. The method of claim 2, further comprising the storage device first writing the write data to a reserved device from among the plurality of nonvolatile memory devices before the write data are written to the first target device, when the read command directs reading read data from the first target device.

5. The method of claim 4, further comprising the storage device writing the write data from the reserved device to the first target device after reading the read data from the first target device.

6. The method of claim 1, wherein a transmission frame from the host includes an Ethernet field, an NVMe over fabrics (NVMe-oF) field, an NVMe field for interfacing with the network fabric, the write command and the write data.

7. The method of claim 6, further comprising the storage device extracting the write command and the write data without performing protocol translation for the Ethernet field, the NVMe-oF field, and the NVMe field.

8. A storage device comprising:
a plurality of nonvolatile memory devices; and
a storage controller configured to provide interfacing between the plurality of nonvolatile memory devices and a network fabric,
wherein the storage controller comprises
a host interface configured to provide the interfacing with the network fabric,
a memory configured to implement a queue of a single layer, and
a storage manager configured to manage the queue and to control the plurality of nonvolatile memory devices, wherein the storage manager is configured to implement and manage the queue in the memory, for managing a command and data transmitted from a host, and
wherein the queue of the single layer comprises
a command submission queue configured to hold a write command or a read command provided from the host,
a data submission queue configured to write hold data provided together with the write command, wherein the data submission queue is managed independently of the command submission queue, and
a completion queue configured to hold read data output from at least one of the plurality of nonvolatile memory devices in response to the read command.

9. The storage device of claim 8, wherein, when the write command and the read command are successively input, the storage manager is configured to continuously process the write command and the read command.

10. The storage device of claim 9, wherein, when the write command and the read command are directed to a same target nonvolatile memory device, the storage manager is configured to write the write data to a reserved nonvolatile memory device in response to the write command and to read read data from the same target nonvolatile memory device in response to the read command.

11. The storage device of claim 10, wherein the storage manager is configured to move the write data written to the reserved nonvolatile memory device to the same target nonvolatile memory device after the read command is completely executed.

12. The storage device of claim 10, wherein the storage manager is configured to change address mapping of the write data written to the reserved nonvolatile memory device so that an address of the reserved nonvolatile memory device is recognized as an address of the same target nonvolatile memory device.

13. The storage device of claim 8, wherein the command and the data transmitted from the host are provided using a protocol format including an Ethernet field, an NVMe-oF field, and an NVMe field, and
wherein the storage manager is configured to translate the protocol format once and performs interfacing with the plurality of nonvolatile memory devices.

14. A network storage controller which provides interfacing between a plurality of nonvolatile memory devices and a network fabric, the network storage controller comprising:
a host interface configured to provide the interfacing with the network fabric;
a flash interface configured to control the plurality of nonvolatile memory devices;
a working memory configured to implement a queue for processing a command or data provided from a host; and
a processor configured to execute a storage manager,
wherein the storage manager is configured to translate a transmission format of a multi-protocol format provided from the host through the network fabric to the command or the data,
wherein the queue corresponds to a single protocol layer and is divided into a command submission queue and a data submission queue.

15. The network storage controller of claim 14, wherein, when a write command and write data are provided, the processor is configured to write the write command to the command submission queue and to write the write data to the data submission queue.

16. The network storage controller of claim 15, wherein, when a read command is provided following the write command, the processor is configured to write the read command to the command submission queue so that the read command is consecutively executed following the write command.

17. The network storage controller of claim 16, wherein, when a target ID directed by the write command is the same as a target ID directed by the read command, the processor is configured to write the write data to a reserved area of the plurality of nonvolatile memory devices.

18. The network storage controller of claim 17, wherein, when the read command is completely executed, the processor is configured to move the write data stored in the reserved area to a nonvolatile memory device from among the plurality of nonvolatile memory devices corresponding to the target ID.
